(19) United States
(12) Patent Application Publication
(10) Pub. No.: US 2022/0141046 A1
(43) Pub. Date: May 5, 2022

(54) METHOD OF ESTABLISHING A VIDEO CONFERENCING NETWORK

(71) Applicant: Jake Strack, Salt Lake City, UT (US)

(72) Inventor: Jake Strack, Salt Lake City, UT (US)

(21) Appl. No.: 17/515,581

(22) Filed: Nov. 1, 2021

Related U.S. Application Data
(60) Provisional application No. 63/107,838, filed on Oct. 30, 2020.

(51) Int. Cl. H04L 12/18; H04N 7/15

(52) U.S. Cl. CPC H04L 12/1827; H04N 7/15

(57) ABSTRACT

The method of establishing a video conferencing network provides for the creation of a plurality of video conferencing clusters on a common platform, such that a virtual venue on the common platform can contain numerous different multi-party video conferences, where the different multi-party conferences are independent and distinct clusters, all held within venue of the common platform. Although the clusters are independent and distinct from one another, the common platform allows the plurality of video conferencing clusters to be interlinked such that a user can selectively transfer connection from one of the clusters to another one of the clusters. The user is provided with at least a limited view of at least a portion of the video conferencing clusters, such as video only of certain clusters, without additional audio, allowing the user to decide if he or she would like to transfer to another cluster.

### CROSS-REFERENCE TO RELATED APPLICATION

This application claims the benefit of U.S. Provisional Patent Application No. 63/107,838, filed on Oct. 30, 2020.

### BACKGROUND

### 1. Field

The disclosure of the present patent application relates to telecommunication, and particularly to a method of establishing a video conferencing network which allows for the creation of a plurality of video conferencing clusters on a common platform.

### 2. Description of the Related Art

Video conferencing has become very common for both business and social communication. With ever-increasing bandwidth and networking speeds, it is becoming easier and easier to establish online video networking between large numbers of users without a loss of video or audio quality. However, despite the great advances made in video conferencing, present video conferencing systems are not able to simulate the most basic aspects of in-person conferences and social gatherings. As an example, at a typical in-person conference, the various attendees gather together to hear one or more speakers, but then split up into smaller groups, often to discuss various specialized issues. Similarly, at a typical party, although there is a main gathering area, people tend to break off into individual groups. For both conferences and parties in the real world, multiple rooms are typically available for such splitting off. Present video conferencing systems are limited to a single virtual meeting area, and do not provide the ability to either establish or virtually travel between smaller groups of users. Thus, a method of establishing a video conferencing network solving the aforementioned problems is desired.

### SUMMARY

The method of establishing a video conferencing network provides for the creation of a plurality of video conferencing clusters on a common platform, such that a virtual venue on the common platform can contain numerous different multi-party video conferences, where the different multi-party conferences are independent and distinct clusters, all held within venue of the common platform. Although the clusters are independent and distinct from one another, the common platform allows the plurality of video conferencing clusters to be interlinked such that a user can selectively transfer connection from one of the clusters to another one of the clusters. The user is provided with at least a limited view of at least a portion of the video conferencing clusters, such as video only of certain clusters, without additional audio, allowing the user to decide if he or she would like to transfer to another cluster.

Each user initially connects to the common platform, which serves as a common virtual venue. Individual clusters of users may then be created, where each cluster represents a type of virtual room, allowing for the creation of multiple video conferencing clusters from the common virtual venue. The plurality of video conferencing clusters are interlinked through the common platform, allowing a user to selectively transfer connection from one cluster to another.

Since the plurality of video conferencing clusters are interlinked, a user may either freely choose another cluster to join or, alternatively, one or more of the clusters may be operated in a private mode, allowing membership to be limited and controlled. In addition to privacy settings for clusters, two or more users may also choose to engage in private conversation by establishing a direct communications link between the users outside of any particular cluster.

These and other features of the present subject matter will become readily apparent upon further review of the following specification.

### BRIEF DESCRIPTION OF THE DRAWINGS

FIG. 1 diagrammatically illustrates a high-level system architecture for implementing the method of establishing a video conferencing network.

FIG. 2 diagrammatically illustrates the creation of clusters interlinked through a common platform in the method of establishing a video conferencing network.

Similar reference characters denote corresponding features consistently throughout the attached drawings.

### DETAILED DESCRIPTION OF THE PREFERRED EMBODIMENTS

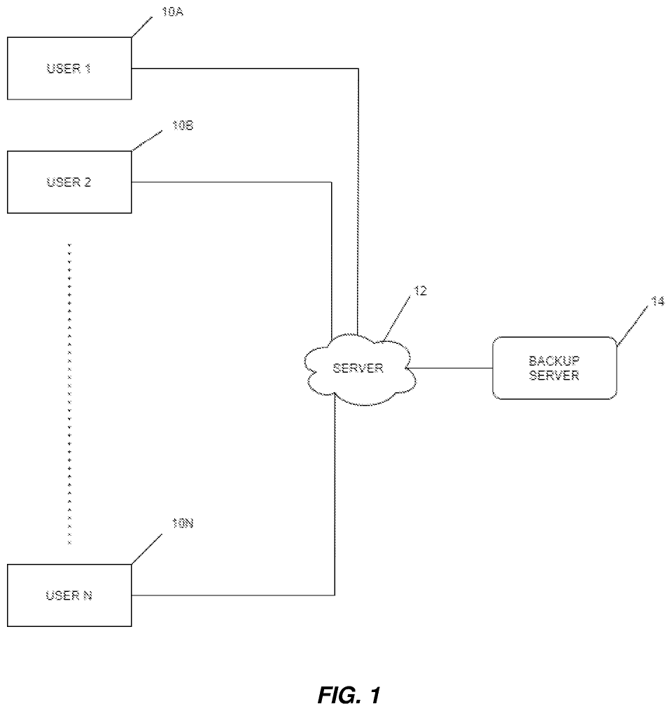

The method of establishing a video conferencing network provides for the creation of a plurality of video conferencing clusters on a common platform, such that a virtual venue on the common platform can contain numerous different multi-party video conferences, where the different multi-party conferences are independent and distinct clusters, all held within venue of the common platform. The common platform and the clusters can be hosted on server 12, as illustrated in FIG. 1, which may be a conventional web server or the like, as is well-known in the art. In FIG. 1, an arbitrary number N users 10A, 10B, . . . , 10N are shown connecting to server 12, and it should be understood that any suitable networking medium may be used for communication, such as, for example, the Internet, the World Wide Web, a local area network, a mobile network, or the like. As a non-limiting example, a user may connect to a central website hosted on server 12, with all access by the user taking place through the user's web browser. In order to provide fault tolerance and uninterrupted service, server 12 may be mirrored by a backup server 14, as shown.

It should be understood that server 12, and the communication links to the server 12, may employ any suitable type of networking security. As a non-limiting example, both the software and hardware associated with implementing the method of establishing a video conferencing network may employ 128-bit Advanced Encryption Standard (AES) protection.

Although the clusters are independent and distinct from one another, the common platform allows the plurality of video conferencing clusters to be interlinked such that a user can selectively transfer connection from one of the clusters to another one of the clusters. The user is provided with at least a limited view of at least a portion of the video conferencing clusters, such as video only of certain clusters, without additional audio, allowing the user to decide if he or she would like to transfer to another cluster.

Each user 10A, 10B, . . . , 10N initially connects to the common platform hosted on server 12, which serves as a common virtual venue. It should be understood that any suitable type of video conferencing methods and software may be used to establish video conferencing within the common platform by the users. As a non-limiting example, as in a conventional videoconferencing system, server 12 may host or include a multipoint control unit (MCU) which, as is well-known in the art, connects all users of a video conferencing system within a single network and provides a wide range of functions. The MCU is a video transcoding server, which may be integrated into server 12 or used in conjunction therewith, and provides data security, stability, video and sound quality, audio and video switching, coordination between different user devices and server 12, and also acts as H.323 gatekeeper for managing calls. The MCU also performs mixing, transcoding and transrating. The mixing performed by the MCU allows for selection of a video layout that is convenient for all conference users. Transcoding changes the video stream format, and transrating optimizes the data transfer rate. The MCU also controls the load on the endpoints.

As discussed above, server 12 may utilize any suitable system or method for implementing video conferencing. As a non-limiting example, the Web Real-Time Communication (WebRTC) protocol may be used to establish video chat on two or more user devices and/or server 12. In WebRTC, the connection can be made using one of two modes: peer-to-peer and relayed connection. WebRTC requires a client to use a signaling service to communicate messages with their peer or peers.

Once signaling has taken place, video/audio/data is streamed directly between clients, using WebRTC's PeerConnection Application Programming Interface (API). This peer-to-peer direct connection allows users to stream high-bandwidth robust data, such as video. Any suitable signaling service, such as PubNub®, for example, may be used. The WebRTC framework powers video, audio and data communication between multiple browsers associated with the multiple users. The PubNub® library includes a “presence” feature to see who is online or offline.

If publicly accessible IP addresses are not an option, such as on enterprise Wi-Fi networks, a WebRTC connection must be established over TCP using a Traversal Using Relays around NAT (TURN) server. The Interactive Connectivity Establishment (ICE) framework will decide if this is necessary as users are trying to connect. A TURN server acts as a relay for video and audio data.

As another non-limiting example, the Agora® Real-time Communication (RTC) software development toolkit (SDK) may be used for enabling real-time audio and video communications, including voice calling, video calling, audio broadcasting and video broadcasting. Further, PubNub® may be integrated with the Agora® RTC to implement audio/video communication. Beyond supporting in-app chat messaging, PubNub® acts as a signaling layer to orchestrate video and VoIP calls of any size, and to underpin live-streaming, large-audience events. PubNub® also allows users to log chat events around the call itself to capture complete details and histories for later use. Other non-limiting examples of video conferencing systems that can be used include CometChat®, Twilio®, Jitsi®, and Amazon Chime®.

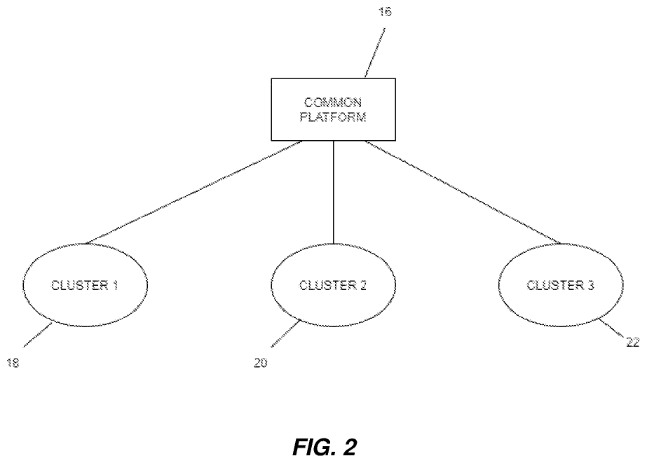

From the common platform, or virtual venue, which is open to all users 10A, 10B, . . . , 10N, individual clusters of users may then be created, where each cluster represents a type of virtual room, allowing for the creation of multiple video conferencing clusters from the common virtual venue. In FIG. 2, three such individual clusters 18, 20, 22 are shown branching from common platform 16, however, it should be understood that the particular number of clusters shown in FIG. 2 is shown for exemplary purposes only, and that any desired number of clusters may be created. Additionally, it should be understood that any desired number of users may be conferenced together within a single cluster. Since the plurality of video conferencing clusters 18, 20, 22 are interlinked through the common platform 16, a user may selectively transfer from one cluster to another. For example, if a user enters the first cluster 18 from the common platform 16, the user may then decide to move from first cluster 18 to the third cluster 22.

Since the plurality of video conferencing clusters are interlinked, a user may either freely choose another cluster to join or, alternatively, one or more of the clusters may be operated in a private mode, allowing membership to be limited and controlled. As an example, the first and second clusters 18, 20 may both be open clusters, allowing a user to join either of them, but third cluster 22 may be operated in a private mode, allowing only select users to join. In addition to privacy settings for clusters, two or more users may also choose to engage in private conversation by establishing a direct communications link between the users outside of any particular cluster.

As a non-limiting example, in use, each user may be given a view of the users within each freely accessible, or open, cluster. In order to avoid the confusion of cross-talk, the audio component may be silenced during this virtual “tour” of the clusters. Thus, if the user in the first cluster 18 decides to leave the first cluster 18, he or she may first virtually view the users in the second cluster 20, seeing their avatars and/or profiles without the audio of second cluster 20, and may choose to enter second cluster 20 based on the users he or she viewed during the virtual “tour”.

Each cluster may have a host, such as, for example, a party host or the person in charge of giving a lecture, and the host may have access to various cluster control options, such as volume control, private invitations, controlling who may speak (i.e., having control over one-way or two-way audio communication associated with each user in the cluster), etc.

As discussed above, the users may connect to server 12 using any suitable type of devices and any suitable type of connections, including both wired and wireless connections. It should be understood that the method of establishing a video conferencing network may be practiced on a local network, a private network, a public network, or a wide area network, such as the World Wide Web. It should be further understood that the users may connect to server using any suitable type of device, such as, for example, desktop computers, laptop computer, touch-screen devices, smartphones or the like.

It is to be understood that the method of establishing a video conferencing network is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

I claim:

1. A method of establishing a video conferencing network, comprising the steps of:
establishing a plurality of video conferencing clusters on a common platform; and
interlinking the plurality of video conferencing clusters such that a user can selectively transfer connection from one of the plurality of video conferencing clusters to another one of the plurality of video conferencing clusters.

2. The method of establishing a video conferencing network as recited in claim 1, further comprising the step of making at least one of the plurality of video conferencing clusters private.

3. The method of establishing a video conferencing network as recited in claim 1, further comprising the step of providing the user with at least a limited view of at least a portion of the plurality of video conferencing clusters.

4. The method of establishing a video conferencing network as recited in claim 3, wherein the at least a limited view of the at least a portion of the plurality of video conferencing clusters is provided without audio.

5. The method of establishing a video conferencing network as recited in claim 1, further comprising the step of establishing private communication between the user and another user.
